(19) United States
(12) Patent Application Publication
(10) Pub. No.: US 2015/0061954 A1
(43) Pub. Date: Mar. 5, 2015

(54) ANTENNA ASSEMBLY

(71) Applicant: CHIUN MAI COMMUNICATION SYSTEMS, INC., New Taipei (TW)

(72) Inventor: TZE-HSUAN CHANG, New Taipei (TW)

(21) Appl. No.: 14/468,008

(22) Filed: Aug. 25, 2014

(30) Foreign Application Priority Data
Aug. 28, 2013 (CN) 2013205292191

(51) Int. Cl. H01Q 5/00; H01Q 13/10

(52) U.S. Cl. CPC H01Q 5/0041; H01Q 13/10
USPC 343/767

(57) ABSTRACT

An antenna assembly includes a base board. A ground plane is positioned on the base board and is configured to provide a ground for the antenna assembly. An antenna is formed by removing a portion of the ground plane to define a slot antenna. A matching unit is electronically connected to the antenna and is configured to match an impedance of the antenna and adjust a bandwidth of the antenna.

### FIELD

The subject matter herein generally relates to an antenna assembly.

### BACKGROUND

Antennas are usually assembled in a wireless communication device to send and/or receive signals.

Antennas are usually assembled in a wireless communication device to send and/or receive signals. Commonly, frequencies of the antennas are broadened by adding an additional antenna based on a main antenna.

### BRIEF DESCRIPTION OF THE DRAWINGS

Implementations of the present technology will now be described, by way of example only, with reference to the attached figures.

FIG. 1 is an isometric view of an embodiment of an antenna assembly.

FIG. 2 is a circuit diagram of a matching unit of the antenna assembly of FIG. 1.

FIG. 3 is a diagram showing return loss (RL) measurements of the antenna assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

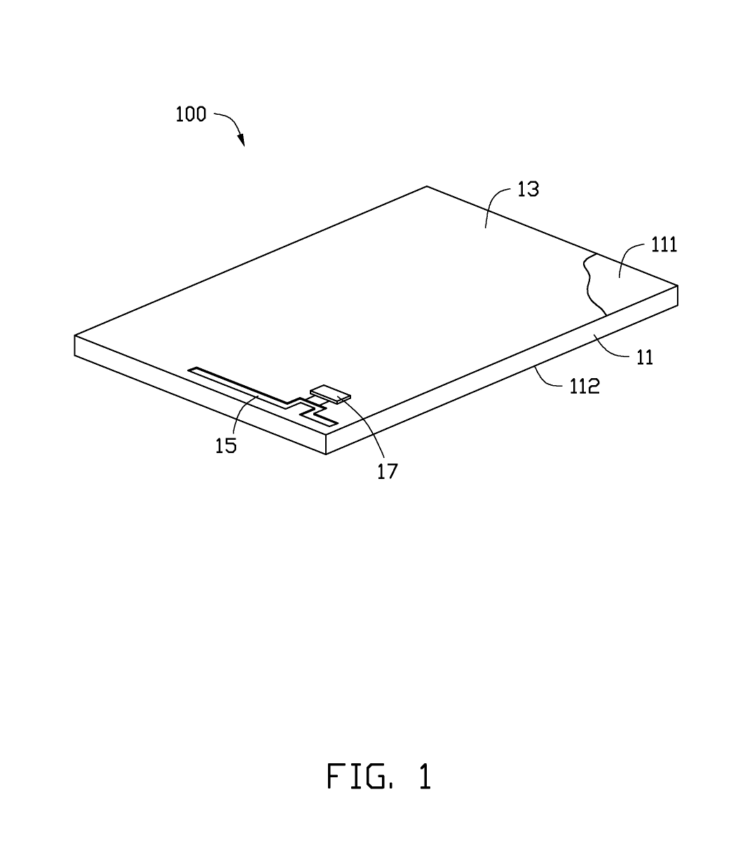

FIG. 1 illustrates an embodiment of an antenna assembly 100. The antenna assembly 100 includes a base board 11. A ground plane 13 is positioned on the base board 11 and is configured to provide a ground for the antenna assembly 100. An antenna 15 is formed by removing a portion of the ground plane 13 to define a slot antenna. A matching unit 17 is shown that is electronically connected to the antenna 15 and is configured to match an impedance of the antenna 15 for adjusting a bandwidth of the antenna 15.

The base board 11 is a substantially flat board and can be made of a dielectric material, such as an epoxy resin glass fiber. The base board 11 includes a first surface 111 and a second surface 112 parallel with, and opposite to, the first surface 111. The first surface 111 can be a top surface of the base board 11. The second surface 112 can be a bottom surface of the base board 11.

The ground plane 13 can be formed by a conductive foil, such as copper foil, and can be plated on the first surface 111. That is, the first surface 111 is covered with the ground plane 13. In the embodiment, there is no conductive foil plated on a portion of the first surface 111 (for example, a corner of the first surface 111) to expose a portion of the first surface 111.

The antenna 15 is defined by removing a portion of the conductive foil to expose the dielectric material of the base board 10.

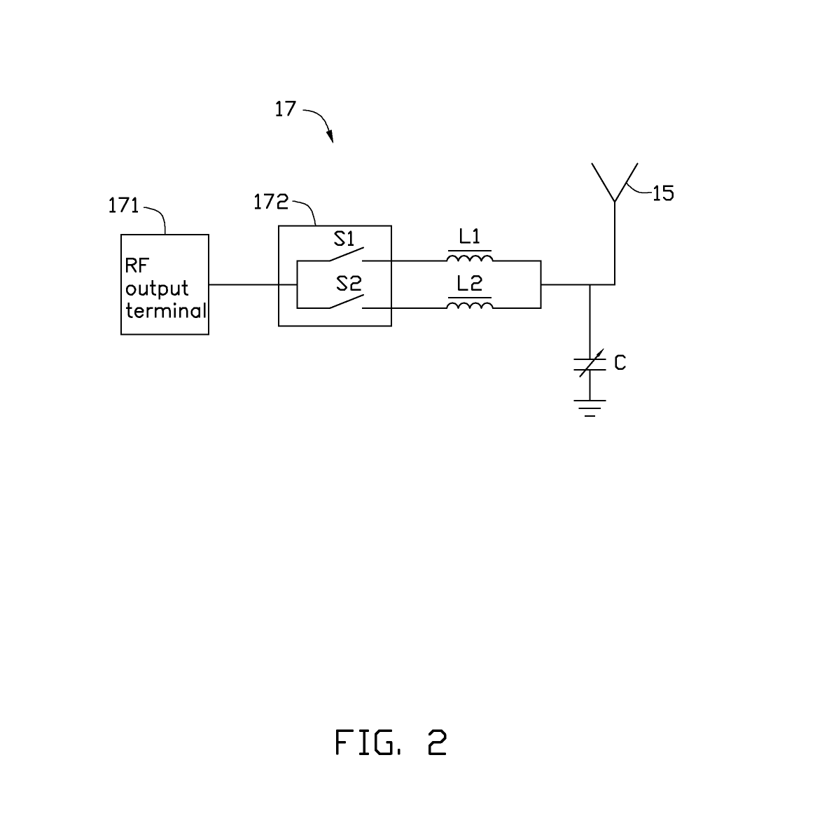

FIG. 2 illustrates that the matching unit 17 has a radio frequency (RF) output terminal 171. The RF output terminal 171 is positioned on the ground plane 13 and is configured to feed signal for the antenna 15.

The matching unit 17 further includes a switch module 172, a first inductor L1, a second inductor L2, and an adjustable capacitor C. The switch module 172 includes a first switch S1 and a second switch S2. The first switch S1 and the second switch S2 can be mechanical switches, electronic switches or chips. An end of the first switch S1 is electronically connected to the RF output terminal 171. Another end of the first switch S1 is electronically connected to an end of the first inductor L1. An end of the second switch S2 is electronically connected to the RF output terminal 171. Another end of the second switch S2 is electronically connected to an end of the second inductor L2. Another end of the first inductor L1 and another end of the second inductor L2 are electronically connected together and are both electronically connected to the antenna 15 and an end of the adjustable capacitor C. Another end of the adjustable capacitor C is grounded.

In the embodiment, an inductance of the first inductor L1 is about 1.8 nH, an inductance of the second inductor L2 is about 8 nH, a capacitance of the adjustable capacitor C is about 2 pF to 4.5 pF.

When the first switch S1 is turned on and the second switch S2 is turned off, the first inductor L1 and the adjustable capacitor C are selected to be electronically connected to the RF output terminal 171 by the turned-on first switch S1. Signal output by the RF output terminal 171 is transmitted to the antenna 15 by the first inductor L1 and the adjustable capacitor C. When the first switch S1 is turned off and the second switch S2 is turned on, the second inductor L2 and the adjustable capacitor C are selected to be electronically connected to the RF output terminal 171 by the turned-on second switch S2. Signal output by the RF output terminal 171 is transmitted to the antenna 15 by the second inductor L2 and the adjustable capacitor C.

When the first inductor L1 or the second inductor L2 is selected, the adjustable capacitor C can be adjusted to match with the first inductor L1 or the second inductor L2 for matching an impedance of the antenna 15 to broaden a bandwidth of the antenna 15 in a high-frequency band. When the first switch S1 is turned on and the second switch S2 is turned off to select the first inductor L1 and the adjustable capacitor C, a capacitance of the adjustable capacitor C can be adjusted to a first value (for example, 3.5 Pf), and the antenna 15 can be adjusted to a dual-frequency mode from a single-frequency mode to obtain a first bandwidth. When the first switch S1 is turned off and the second switch S2 is turned on to select the second inductor L2 and the adjustable capacitor C, a capacitance of the adjustable capacitor C can be gradually increased from a second value, and a central frequency of the antenna 15 can be moved to a low-frequency range to obtain a second bandwidth. In this embodiment, the capacitance of the adjustable capacitor C is gradually increased from 3.3 Pf to 3.7 Pf and 4.5 Pf.

When the first switch S1 is turned off and the second switch S2 is turned on to select the second inductor L2 and the adjustable capacitor C, a capacitance of the adjustable capacitor C can be gradually decreased from the second value, and the central frequency of the antenna 15 can be moved to a high-frequency range to obtain a third bandwidth. In this embodiment, the capacitance of the adjustable capacitor C is gradually decreased from 3.3 Pf to 2.9 Pf, 2.6 Pf, 2.35 Pf, and 2 Pf.

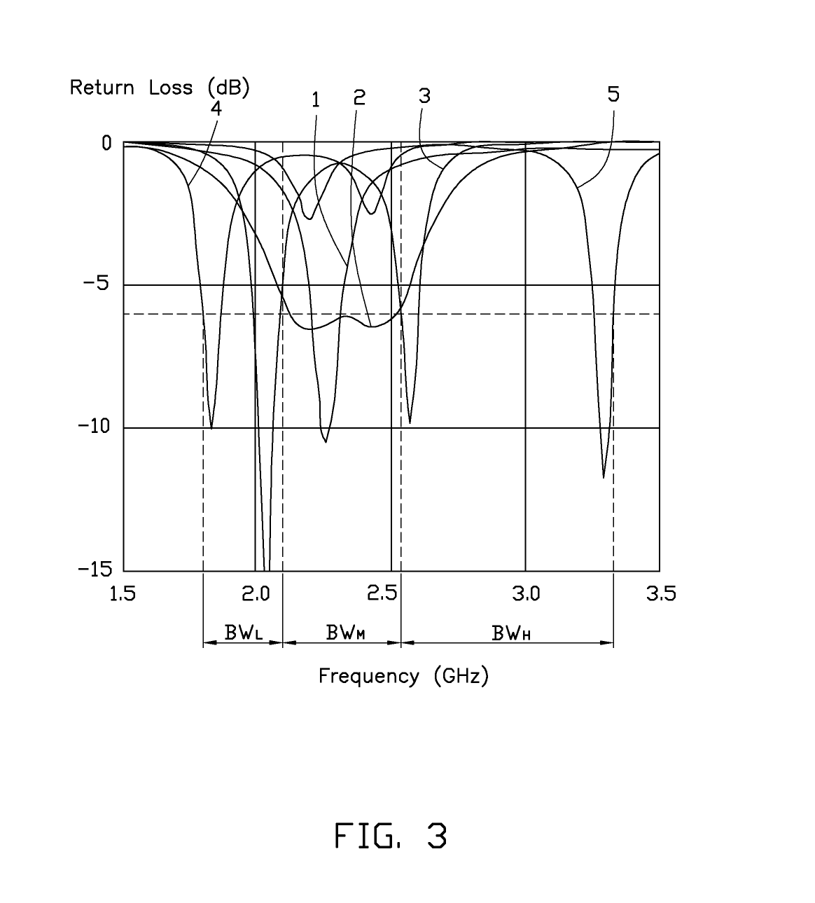

FIG. 3 illustrates a diagram showing a return loss measurement of the antenna assembly 100. Curve 1 represents a working frequency of the antenna assembly 100 when the antenna assembly 100 has no matching unit 17. Curve 2 represents a working frequency of the antenna assembly 100 when the antenna assembly 100 has the matching unit 17. Curve 3 represents a working frequency of the antenna assembly 100 when the first inductor L1 is selected and the capacitance of the adjustable capacitor C is adjusted to the first value, and the antenna assembly 100 has the first bandwidth BW_{M}. Curve 4 represents a working frequency of the antenna assembly 100 when the second inductor L2 is selected and the capacitance of the adjustable capacitor C is gradually increased from the second value, and the antenna assembly 100 has the second bandwidth BW_{L}. Curve 5 represents a working frequency of the antenna assembly 100 when the second inductor L2 is selected and the capacitance of the adjustable capacitor C is gradually decreased from the second value, and the antenna assembly 100 has the third bandwidth BW_{H}.

As shown in FIG. 3, after the matching unit 17 is used in the antenna assembly 100, the antenna assembly 100 can obtain the first bandwidth BW_{M}, the second bandwidth BW_{L}, or the third bandwidth BW_{H} by selecting the first inductor L1 or the second inductor L2 and adjusting a capacitance of the adjustable capacitor C, thereby broadening a bandwidth of the antenna assembly 100.

In other embodiments, the first inductor L1 can be replaced by a plurality of inductors that the sum of the inductances of the plurality of inductors is equal to the inductance of the first inductor L1. The second inductor L2 can be replaced by a plurality of inductors that the sum of the inductances of the plurality of inductors is equal to the inductance of the second inductor L2.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An antenna assembly comprising:
a base board;
a ground plane positioned on the base board and configured to provide a ground for the antenna assembly;
an antenna formed by removing a portion of the ground plane to define a slot antenna; and
a matching unit electronically connected to the antenna and configured to match an impedance of the antenna for adjusting a bandwidth of the antenna.

2. The antenna assembly of claim 1, wherein the base board is made of a dielectric material and comprises a first surface and a second surface opposite to the first surface; the ground plane is positioned on the first surface.

3. The antenna assembly of claim 2, wherein the ground plane is formed by a conductive foil plated on the first surface.

4. The antenna assembly of claim 3, wherein the antenna is defined by removing a portion of the conductive foil to expose the dielectric material of the base board.

5. The antenna assembly of claim 1, wherein the matching unit has a radio frequency (RF) output terminal positioned on the ground plane and configured to feed signal for the antenna.

6. The antenna assembly of claim 5, wherein the matching unit further comprises a switch module, a first inductor, a second inductor, and a adjustable capacitor; the switch module comprises a first switch and a second switch, an end of the first switch is electronically connected to the RF output terminal, another end of the first switch is electronically connected to an end of the first inductor; an end of the second switch is electronically connected to the RF output terminal, another end of the second switch is electronically connected to an end of the second inductor; and another end of the first inductor and another end of the second inductor are connected together and are both electronically connected to the antenna and an end of the adjustable capacitor; another end of the adjustable capacitor is grounded.

7. The antenna assembly of claim 6, wherein an inductance of the first inductor is about 1.8 nH, an inductance of the second inductor is about 8 nH, and a capacitance of the adjustable capacitor is about 2 pF to 4.5 pF.

8. The antenna assembly of claim 6, wherein when the first switch is turned on and the second switch is turned off, the first inductor and the adjustable capacitor are selected to be electronically connected to the RF output terminal by the turned-on first switch; when the first switch is turned off and the second switch is turned on, the second inductor and the adjustable capacitor are selected to be electronically connected to the RF output terminal by the turned-on second switch; when the first inductor or the second inductor is selected, the adjustable capacitor is adjusted to match with the first inductor or the second inductor for matching the impedance of the antenna.

9. The antenna assembly of claim 8, wherein when the first switch is turned off and the second switch is turned on to select the first inductor and the adjustable capacitor, a capacitance of the adjustable capacitor is adjusted to a first value, and the antenna is adjusted to a dual-frequency mode from a single-frequency mode to obtain a first bandwidth.

10. The antenna assembly of claim 8, wherein when the first switch is turned off and the second switch is turned on to select the second inductor and the adjustable capacitor, a capacitance of the adjustable capacitor is gradually increased from a second value, and a central frequency of the antenna is moved to a low-frequency range to obtain a second bandwidth.

11. The antenna assembly of claim 8, wherein when the first switch is turned off and the second switch is turned on to select the second inductor and the adjustable capacitor, a capacitance of the adjustable capacitor is gradually decreased from a second value, and a central frequency of the antenna is moved to a high-frequency range to obtain a third bandwidth.

12. An antenna assembly comprising:
a base board;
a ground plane positioned on the base board and configured to provide a ground for the antenna assembly;
an antenna formed by removing a portion of the ground plane to define a slot antenna; and
a matching unit electronically connected to the antenna and configured to match an impedance of the antenna and make the antenna obtaining a first bandwidth, a second bandwidth, and a third bandwidth.

13. The antenna assembly of claim 12, wherein the base board comprises a first surface and a second surface parallel with and opposite to the first surface; the ground plane is formed by a conductive foil plated on the first surface.

14. The antenna assembly of claim 13, wherein the antenna is defined by removing a portion of the conductive foil to expose a dielectric material of the base board.

15. The antenna assembly of claim 12, wherein the matching unit has a radio frequency (RF) output terminal positioned on the ground plane and configured to feed signal for the antenna.

16. The antenna assembly of claim 15, wherein the matching unit further comprises a switch module, a first inductor, a second inductor, and a adjustable capacitor; the switch module comprises a first switch and a second switch, an end of the first switch is electronically connected to the RF output terminal, another end of the first switch is electronically connected to an end of the first inductor; an end of the second switch is electronically connected to the RF output terminal, another end of the second switch is electronically connected to an end of the second inductor; and another end of the first inductor and another end of the second inductor are connected together and are both electronically connected to the antenna and an end of the adjustable capacitor; another end of the adjustable capacitor is grounded.

17. The antenna assembly of claim 16, wherein when the first switch is turned on and the second switch is turned off, the first inductor and the adjustable capacitor are selected to be electronically connected to the RF output terminal by the turned-on first switch; when the first switch is turned off and the second switch is turned on, the second inductor and the adjustable capacitor are selected to be electronically connected to the RF output terminal by the turned-on second switch; when the first inductor or the second inductor is selected, the adjustable capacitor is adjusted to match with the first inductor or the second inductor for matching the impedance of the antenna.

18. The antenna assembly of claim 17, wherein when the first switch is turned off and the second switch is turned on to select the first inductor and the adjustable capacitor, a capacitance of the adjustable capacitor is adjusted to a first value, and the antenna is adjusted to a dual-frequency mode from a single-frequency mode to obtain the first bandwidth.

19. The antenna assembly of claim 18, wherein when the first switch is turned off and the second switch is turned on to select the second inductor and the adjustable capacitor, a capacitance of the adjustable capacitor is gradually increased from a second value, and a central frequency of the antenna is moved to a low-frequency range to obtain the second bandwidth.

20. The antenna assembly of claim 18, wherein when the first switch is turned off and the second switch is turned on to select the second inductor and the adjustable capacitor, a capacitance of the adjustable capacitor is gradually decreased from a second value, and a central frequency of the antenna is moved to a high-frequency range to obtain the third bandwidth.
